(19) United States
(12) Patent Application Publication
(10) Pub. No.: US 2012/0069792 A1
(43) Pub. Date: Mar. 22, 2012

(54) COMMUNICATION APPARATUS, RELAY APPARATUS, COMMUNICATION SYSTEM, METHOD FOR CONTROLLING A COMMUNICATION APPARATUS, PROGRAM, AND RECORDING MEDIUM

(76) Inventor: Hiroyuki Kishida, Osaka (JP)

(21) Appl. No.: 13/322,425

(22) PCT Filed: May 25, 2010
(86) PCT No.: PCT/JP2010/058820

§ 371 Date: Nov. 23, 2011

(30) Foreign Application Priority Data
May 28, 2009 (JP) 2009-129525

(51) Int. Cl. H04B 7/14

(52) U.S. Cl. 370/315

(57) ABSTRACT

Pairing is carried out with no user operation for a communication apparatus. A client device (4) of the present invention including: a notification signal detecting section (70) for detecting receipt of a notification signal for informing a user of a communication network or an apparatus each connectable via a router; and a client side pairing performing section (72) for carrying out pairing with respect to the router upon detection, by the notification signal detecting section (70), of receipt of the notification signal. The user can consequently carry out pairing between the client device (4) and the router without carrying out any input operation for the client device (4).

### TECHNICAL FIELD

The present invention relates to a communication apparatus that connects to, for example, a communication network via a relay apparatus. More particularly, the present invention relates to, for example, a communication apparatus that carries out pairing with respect to a relay apparatus and that connects to the relay apparatus, which has been paired with the communication apparatus, via wireless telecommunications so as to connect to the communication network.

### BACKGROUND ART

Recent years have witnessed an increasing use of wireless telecommunications in communication between electronic devices. For instance, while the mainstream of a LAN (local area network) was conventionally a wired LAN, use of a wireless LAN is on the increase in recent years.

Wireless telecommunications are advantageous over cable communications in that they (i) impose fewer restrictions with regard to placement of electronic devices to communicate with each other and (ii) require no wiring to connect the electronic devices with each other. Wireless telecommunications are, on the other hand, disadvantageous in that they involve a risk of, for example, a communication being intercepted and a network being intruded into by an outsider.

In view of overcoming the above disadvantage, carrying out a wireless telecommunication involves a process called pairing that is first carried out between apparatuses intended to carry out a wireless telecommunication with each other. Carrying out pairing allows each apparatus intended to carry out a wireless telecommunication to register setting information (for example, SSID [service set identifier] and security setting) necessary for a wireless telecommunication. With such an arrangement in which each apparatus intended to carry out a wireless telecommunication obtains setting information necessary for a wireless telecommunication by carrying out pairing as above, it is possible to prevent a communication connection by an outsider that has not carried out pairing.

In carrying out pairing, both apparatuses that are to carry out pairing are first switched to a pairing mode, in which they carry out pairing. Both apparatuses that are to carry out pairing, while in the pairing mode, transmit and receive to and from each other setting information necessary for a wireless telecommunication. This completes pairing.

A conventionally used method for switching an apparatus to a pairing mode is by including a button for pairing in an apparatus so that the apparatus is switched to a pairing mode in response to a trigger of a press of the button. The following describes this method with reference to FIG. 6. FIG. 6 illustrates an exterior appearance of a conventional router 100, where (a) of FIG. 6 is a perspective view of the router 100, and (b) of FIG. 6 is a side view of the router 100 which side view is taken along an arrow A shown in (a) of FIG. 6.

The router 100 is a device for relaying data between a WAN (wide area network) and a LAN. As illustrated in (a) of FIG. 6, the router 100 is arranged such that a wireless LAN card 101 can be attached thereto. Attaching the wireless LAN card 101 to the router 100 allows the router 100 to function as a wireless LAN access point.

As illustrated in (b) of FIG. 6, the router 100 includes, on a side surface thereof, members such as a pairing button 102 for switching the router 100 to a pairing mode, LAN ports 103 each for connecting a line with a LAN, and a WAN port 104 for connecting a line to a WAN.

The router 100 is switched to a pairing mode in response to a press of the pairing button 102 in the state in which the wireless LAN card 101 is attached to the router 100. The router 100, while in the pairing mode, carries out pairing with respect to, for example, a communication apparatus that has a wireless telecommunication function, such as a notebook PC (personal computer). This allows the notebook PC and the router 100 to carry out a wireless LAN communication with each other.

The above arrangement of switching a router to a pairing mode in response to a trigger of a press of a pairing button included in the router is disclosed in, for example, Patent Literature 1 below. The above technique of carrying out pairing in a relay apparatus such as a router is disclosed in, for example, Patent Literatures 2 through 6 below.

### CITATION LIST

Patent Literature 1
Japanese Patent Application Publication, Tokukai, No. 2004-215232 A (Publication Date: Jul. 29, 2004)

Patent Literature 2
Japanese Patent Application Publication, Tokukai, No. 2006-203289 A (Publication Date: Aug. 3, 2006)

Patent Literature 3
Japanese Patent Application Publication, Tokukai, No. 2006-203681 A (Publication Date: Aug. 3, 2006)

Patent Literature 4
Japanese Patent Application Publication, Tokukai, No. 2008-193597 A (Publication Date: Aug. 21, 2008)

Patent Literature 5
Japanese Patent Application Publication, Tokukai, No. 2005-318048 A (Publication Date: Nov. 10, 2005)

Patent Literature 6
Japanese Patent Application Publication (Translation of PCT Application), Tokuhyou, No. 2007-507965 (Publication Date: Mar. 29, 2007)

### SUMMARY OF INVENTION

### Technical Problem

In carrying out pairing, apparatuses that are to carry out pairing both need switching to a pairing mode as described above. Specifically, carrying out pairing with respect to the router 100 of FIG. 6 requires (i) pressing the pairing button 102 to switch the router 100 to the pairing mode and (ii) carrying out a predetermined input operation with respect to a communication apparatus (for example, a notebook PC) as a pairing target to also switch the communication apparatus to the pairing mode. Patent Literatures 1 through 6, while disclosing various pairing methods, share a common requirement of carrying out a predetermined operation with respect to both pairing target apparatuses individually.

As described above, carrying out pairing between a conventional communication apparatus and a conventional relay apparatus requires a predetermined operation to be carried out with respect to both the communication apparatus and the relay apparatus individually. In other words, conventional communication apparatuses, to carry out a wireless telecommunication with a relay apparatus, problematically require a user to carry out a complicated operation, that is, to carry out an operation with respect to both the communication apparatus and the relay apparatus individually.

The present invention has been accomplished in view of the above problem. It is an object of the present invention to provide, for example, a communication apparatus that can simply carry out pairing with respect to a relay apparatus while requiring no user operation for the communication apparatus.

### Solution to Problem

In order to solve the above problem, a communication apparatus of the present invention is a communication apparatus that carries out pairing with respect to a relay apparatus which transmits a notification signal for informing a presence of a connectable communication network or a connectable apparatus and that carries out a wireless telecommunication with the relay apparatus, with which the communication apparatus has been paired, to communicatively connect to said connectable communication network or said connectable apparatus, the communication apparatus comprising: notification detecting means for detecting receipt of the notification signal; and upon-receipt pairing means for carrying out the pairing with respect to the relay apparatus upon detection, by the notification detecting means, of receipt of the notification signal.

In order to solve the above problem, a method for controlling a communication apparatus that carries out pairing with respect to a relay apparatus which transmits a notification signal for informing a presence of a connectable communication network or a connectable apparatus and that carries out a wireless telecommunication with the relay apparatus, with which the communication apparatus has been paired, to communicatively connect to said connectable communication network or said connectable apparatus, the method comprising the steps of: (A) detecting receipt of the notification signal; and (B) carrying out the pairing with respect to the relay apparatus upon detection, in the step (A), of receipt of the notification signal.

The above arrangement causes the communication apparatus to carry out pairing automatically upon receipt of a notification signal transmitted by a relay apparatus. The arrangement thus allows a user of the communication apparatus to carry out pairing between the communication apparatus and the relay apparatus very easily without having to carry out a particular operation such as switching the communication apparatus to a pairing mode.

The above notification signal is a signal for informing the user of the presence of a communication network or an apparatus each connectable via the relay apparatus. The relay apparatus transmits such a notification signal to serve its relay function. In other words, the notification signal is automatically transmitted merely by setting the relay apparatus to a state in which it can relay data.

Thus, merely setting the relay apparatus to such a state in which it can relay data causes the relay apparatus to transmit a notification signal, upon receipt of which the communication apparatus carries out pairing with respect to the relay apparatus. The above arrangement thus simply requires the user to set the relay apparatus to a state in which it can relay data, for example, to turn on the relay apparatus. Without carrying out any operation thereafter, the user can carry out pairing between the communication apparatus and the relay apparatus.

The above pairing is a process necessary for a wireless telecommunication between the relay apparatus and the communication apparatus. Carrying out pairing allows the relay apparatus and the communication apparatus to carry out a wireless telecommunication with each other. The pairing may be carried out in response to (i) a transmission, by the communication apparatus, of a request for pairing to the relay apparatus or (ii) a transmission, by the relay apparatus, of a request for pairing to the communication apparatus.

### Advantageous Effects of Invention

As described above, a communication apparatus of the present invention includes notification detecting means for detecting receipt of the notification signal; and upon-receipt pairing means for carrying out the pairing with respect to the relay apparatus upon detection, by the notification detecting means, of receipt of the notification signal.

A method of the present invention for controlling a communication apparatus includes the steps of: (A) detecting receipt of the notification signal; and (B) carrying out the pairing with respect to the relay apparatus upon detection, in the step (A), of receipt of the notification signal.

The above arrangement causes the communication apparatus to carry out pairing automatically upon receipt of a notification signal transmitted by a relay apparatus. The arrangement thus advantageously allows a user of the communication apparatus to carry out pairing between the communication apparatus and the relay apparatus very easily without having to carry out a particular operation such as switching the communication apparatus to a pairing mode.

### BRIEF DESCRIPTION OF DRAWINGS

FIG. 1 is a block diagram illustrating a main configuration of a client device in accordance with an embodiment of the present invention.

FIG. 2 is a block diagram illustrating a main configuration of a router in accordance with the embodiment of the present invention, the router carrying out a wireless telecommunication with the client device.

FIG. 3 is a block diagram illustrating a main configuration of a communication system including the router and the client device.

FIG. 4 is a flowchart illustrating an example process carried out by the router.

FIG. 5 is a flowchart illustrating an example process carried out by the client device.

FIG. 6 illustrates an exterior appearance of conventional router, where (a) is a perspective view of the router, and (b) is a side view of the router.

### DESCRIPTION OF EMBODIMENTS

An embodiment of the present invention is described below in detail with reference to FIGS. 1 through 5. The present embodiment is, as an example implementation of the present invention, a communication system including (i) a router having the function of the above communication apparatus and (ii) a client apparatus having the function of the communication target apparatus.

[System Configuration]

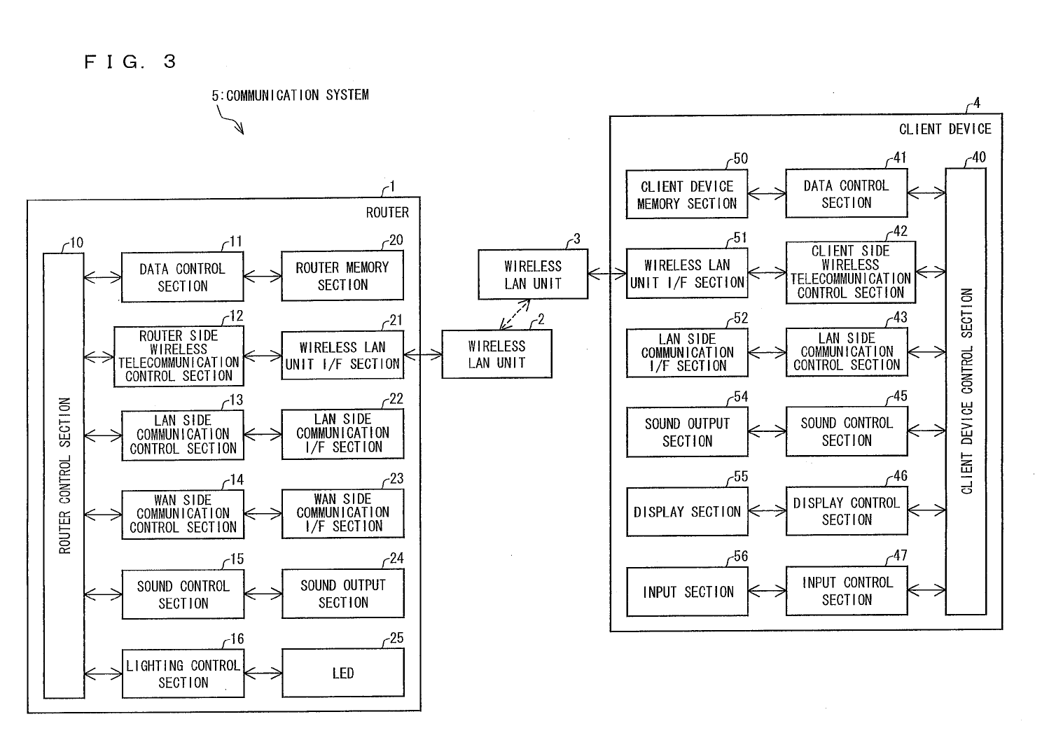

The following first describes a schematic configuration of the communication system with reference to FIG. 3. FIG. 3 is a block diagram illustrating a main configuration of the communication system of the present invention. As illustrated in FIG. 3, the communication system 5 includes a router (relay apparatus) 1 and a client device (communication apparatus) 4. The router 1 is provided with a wireless LAN unit (wireless telecommunication section) 2, whereas the client device 4 is provided with a wireless LAN unit 3. The router 1 and the client device 4 are arranged to be capable of a wireless LAN communication with each other via the wireless LAN units 2 and 3.

The router 1 is a relay apparatus that allows the client device 4 to connect to a LAN or a wireless LAN so as to communicate with a terminal on a WAN or a LAN. As illustrated in FIG. 3, the router 1 includes: a router control section 10; a data control section 11; a router side wireless telecommunication control section 12; a LAN side communication control section 13; a WAN side communication control section 14; a sound control section 15; a lighting control section 16; a router memory section 20; a wireless LAN unit I/F section (attachment section) 21; a LAN side communication I/F section 22; a WAN side communication I/F section 23; a sound output section 24; and an LED 25.

The router control section 10 centrally controls an operation of the router 1, and can include, for example, a CPU (central processing unit). The router control section 10 operates by (i) reading out, for example, a program stored in the router memory section 20 to a primary memory section (not shown) constituted by, for example, a RAM (random access memory) and (ii) executing the program. The router control section 10 is described below in further detail.

The data control section 11 reads out data from the router memory section 20 and writes data in the router memory section 20 in accordance with an instruction by the router control section 10.

The router side wireless telecommunication control section 12 controls an operation of the wireless LAN unit 2 connected with the wireless LAN unit I/F section 21, which is an interface for connecting the wireless LAN unit 2 with the router 1. The router 1 thus carries out a wireless LAN communication via the wireless LAN unit 2. The router side wireless telecommunication control section 12 further carries out a control of transmitting to the outside of the router 1 a notification signal (beacon signal) for informing an external apparatus of a communication network or apparatus that is connectable via the router 1.

The LAN side communication control section 13 controls a communication with an apparatus connected with the LAN side communication I/F section 22, which is a wired LAN interface.

The WAN side communication control section 14 controls a communication with an apparatus connected with the WAN side communication I/F section 23, which is a WAN interface.

The sound control section 15, in accordance with an instruction by the router control section 10, causes the sound output section 24 to produce a sound. The lighting control section 16 turns on the LED 25 in accordance with an instruction by the router control section 10. The router control section 10 uses the sound and the lighting to inform a user of, for example, an operation state of the router 1.

The router memory section 20 stores, for example, a program that the router control section 10 executes and various data for use in the router 1. The data stored in the router memory section 20 is described below.

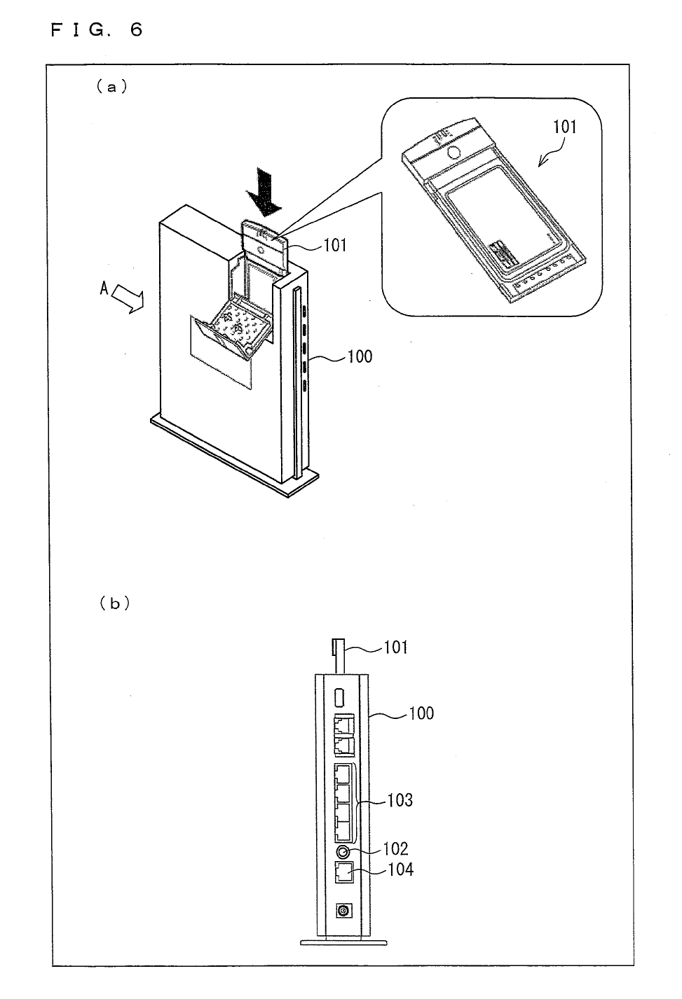

The router 1, as described above, includes no pairing button 102 unlike in the conventional router 100 illustrated in FIG. 6. This allows the router 1 to be produced with fewer parts than the router 100, and can consequently reduce a cost of producing the router 1. Further, the router 1, which has no need to include a button, has a larger degree of freedom in exterior design than the router 100, and can consequently have an improved design as well.

The wireless LAN unit 2 is a communication section for a wireless LAN communication, the communication section being configured to be capable of being attached to and detached from the wireless LAN unit I/F section 21 of the router 1. The wireless LAN unit 2 transmits and receives radio waves under control of the router side wireless telecommunication control section 12. The router 1 thus has the function of a wireless LAN communication.

The wireless LAN unit 3 is a communication section for a wireless LAN communication, the communication section being configured to be capable of being attached to and detached from a wireless LAN unit I/F section 51 of the client device 4. The wireless LAN unit 3 is identical in configuration and function to the wireless LAN unit 2.

The client device 4 connects, via (i) a wireless LAN or a LAN and (ii) the router 1, to a terminal on a WAN or the LAN so as to carry out a communication. The client device 4 is, for example, a notebook PC (personal computer).

As illustrated in FIG. 3, the client device 4 includes: a client device control section 40; a data control section 41; a client side wireless telecommunication control section 42; a LAN side communication control section 43; a sound control section 45; a display control section 46; an input control section 47; a client device memory section 50; a wireless LAN unit I/F section 51; a LAN side communication I/F section 52; a sound output section 54; a display section 55; and an input section 56.

The client device control section 40 centrally controls an operation of the client device 4, and can include, for example, a CPU. The client device control section 40 operates by (i) reading out, for example, a program stored in the client device memory section 50 to a primary memory section (not shown) constituted by, for example, a RAM and (ii) executing the program. The client device control section 40 is described below in further detail.

The data control section 41, the LAN side communication control section 43, the sound control section 45, the wireless LAN unit I/F section 51, the LAN side communication I/F section 52, and the sound output section 54 are identical in function and configuration respectively to the data control section 11, the LAN side communication control section 13, the sound control section 15, the wireless LAN unit I/F section 21, the LAN side communication I/F section 22, and the sound output section 24 all included in the router 1.

The client side wireless telecommunication control section 42 controls an operation of the wireless LAN unit 3 connected with the wireless LAN unit I/F section 51, which is an interface for connecting the wireless LAN unit 3 with the client device 4. The client device 4 thus carries out a wireless LAN communication via the wireless LAN unit 3.

The display control section 46, in accordance with an instruction by the client device control section 40, causes the display section 55 to display an image. The display section 55 is simply required to be capable of displaying an image. The display section 55 can be, for example, an LCD (liquid crystal display) device, or an EL (electroluminescence) display device.

The input control section 47 interprets content of a user's input operation accepted by the input section 56, and thus transmits a signal indicative of the content to the client device control section 40. The input section 56 is simply required to be capable of accepting a user's input operation. The input section 56 can be, for example, a keyboard, a touchpad, or a mouse.

The client device memory section 50 stores, for example, a program that the client device control section 40 executes and various data for use in the client device 4. The data stored in the client device memory section 50 is described below.

In the example of FIG. 3, the client device 4 connects to the wireless LAN unit 3 to have the function of a wireless LAN communication. The client device 4 may, however, have the function of a wireless LAN communication in any manner. The client device 4 may, for example, contain a component functionally equivalent to the wireless LAN unit 3.

As described above, the present embodiment uses, as an example, software for each block of the router 1 and the client device 4, particularly for the router control section 10 and the client device control section 40.

The router 1 and the client device 4 each include a CPU and a memory device. The CPU executes an instruction by a control program for achieving each function. The memory device includes (i) a ROM (read only memory) which contains programs, (ii) a RAM to which the programs are loaded, and (iii) a memory which contains the programs and various data.

The object of the present invention can also be achieved by mounting to each of the router 1 and the client device 4 a computer-readable storage medium containing a code of a control program (an executable program, an intermediate code program, or a source program) for the router 1 or the client device 4, the control program being software for achieving the above functions, in order for the computer (alternatively, a CPU or an MPU) to retrieve and execute the program code contained in the storage medium.

The storage medium may be, for example, (i) a tape such as a magnetic tape and a cassette tape, (ii) a disk such as a magnetic disk (e.g., a Floppy® disk or a hard disk) and an optical disk (e.g., a CD-ROM, an MO, an MD, a DVD, or a CD-R), (iii) a card such as an IC card (memory card) and an optical card, or (iv) a semiconductor memory such as a mask ROM, an EPROM, an EEPROM, and a flash ROM.

The router 1 and the client device 4 may each be provided with the above program code via a communication network to which the router 1 and the client device 4 are connected. The communications network is not limited in any particular manner, and may be, for example, the Internet, an intranet, an extranet, a LAN, an ISDN, a VAN, a CATV a communications network, a virtual dedicated network (virtual private network), a telephone line network, a mobile communications network, or a satellite communications network. The transfer medium which makes up the communications network is not limited in any particular manner, and may be, for example, (i) a wired transfer medium such as IEEE 1394, a USB, an electric power line, a cable TV line, a telephone line, or an ADSL line, or (ii) a wireless transfer medium such as infrared radiation (IrDA, remote control), Bluetooth®, 802.11 wireless, HDR, a mobile telephone network, a satellite line, or a terrestrial digital network.

The functions of each of the router 1 and the client device 4 may be achieved in the form of a computer data signal embedded in a carrier wave in which the program code is embodied electronically. The router control section 10 and the client device control section 40 may each be formed of hardware logic.

[Detailed Configuration of Client Device 4]

The following describes the configuration of the client device 4 in further detail with reference to FIG. 1. FIG. 1 is a block diagram illustrating a main configuration of the client device 4. As illustrated in FIG. 1, the client device control section 40 includes: a notification signal detecting section (notification detecting means) 70; a client side pairing execution determining section (communication apparatus side executability determining means; a pairing completion determining means) 71; and a client side pairing performing section (upon-receipt pairing means) 72. The client device memory section 50 includes: a pairing executability information storing section (communication apparatus side executability information storing section) 73; and a setting information storing section 74.

The notification signal detecting section 70 detects receipt by the client device 4 of a notification signal transmitted by a wireless LAN access point such as the router 1. Specifically, the notification signal detecting section 70 detects receipt, via the wireless LAN unit 3 connected with the client device 4, of a notification signal in which a pairing request signal for requesting pairing is incorporated. The notification signal detecting section 70, upon detection of receipt of a notification signal, communicates such receipt to the client side pairing execution determining section 71.

The client side pairing execution determining section 71 refers to the pairing executability information storing section 73, which stores pairing executability information indicative of whether the client device 4 is currently set to carry out pairing, and thus checks whether the client device 4 carries out pairing. The client side pairing execution determining section 71, in a case where it has determined that the client device 4 carries out pairing, instructs the client side pairing performing section 72 to carry out pairing.

The present embodiment assumes that it is upon receipt from the notification signal detecting section 70 of a communication indicative of receipt of a notification signal that the client side pairing execution determining section 71 determines whether the client device 4 can carry out pairing. When the client side pairing execution determining section 71 determines whether the client device 4 can carry out pairing is, however, not particularly limited, and may be any timing (i) after the client device 4 is turned on and (ii) before the client side pairing execution determining section 71 instructs the client side pairing performing section 72 to carry out pairing.

The client side pairing execution determining section 71 further checks whether the client device 4 has already carried out pairing. How the client side pairing execution determining section 71 checks whether the client device 4 has already carried out pairing is not particularly limited.

With, for example, an arrangement in which the client device 4, in a case where it has carried out pairing, sets a flag indicative of such completion of pairing, the client side pairing execution determining section 71 can determine, on the basis of whether the flag has been set, whether the client device 4 has already carried out pairing. With an arrangement in which the client device 4, as a result of pairing, obtains wireless telecommunication setting information for use in a wireless telecommunication between the router 1 and the client device 4, the client side pairing execution determining section 71 can determine, on the basis of whether such wireless telecommunication setting information is stored, whether the client device 4 has already carried out pairing. Further, with an arrangement in which the client device 4, in a case where it has carried out pairing, obtains information for identification of a pairing target apparatus, the client side pairing execution determining section 71 can determine, on the basis of whether such identification information is stored, whether the client device 4 has already carried out pairing. The client side pairing execution determining section 71 can alternatively transmit an inquiry to a network to determine whether the client device 4 has already carried out pairing.

The wireless telecommunication setting information and the information about a pairing target apparatus may be stored in, for example, the setting information storing section 74. In this case, the client side pairing execution determining section 71 refers to the setting information storing section 74 to determine whether the client device 4 has already carried out pairing.

The client side pairing execution determining section 71 determines carrying out of pairing in a case where it has determined, as a result of the above checks, that (i) the client device 4 is set to carry out pairing and that (ii) the client device 4 has not yet carried out pairing. The client side pairing execution determining section 71 thus instructs the client side pairing performing section 72 to carry out pairing.

The client side pairing performing section 72 carries out a pairing process in response to an instruction by the client side pairing execution determining section 71 to carry out pairing. The client device 4 thus carries out pairing of itself with another apparatus (in the present embodiment, the router 1).

The pairing process is a process carried out in advance for a wireless LAN communication between the client device 4 and a second apparatus. Carrying out a pairing process allows a wireless LAN communication between the client device 4 and such a second apparatus. A pairing process involves, for example, determining wireless telecommunication settings for use in a wireless LAN communication of the client device 4 with a second apparatus. The client device 4 and the second apparatus, as necessary, transmit and receive to and from each other wireless telecommunication setting information indicative of the wireless telecommunication settings thus determined.

The client device 4 is primarily characterized by carrying out in advance, in response to a trigger of detection of receipt of a notification signal, a process that allows a wireless LAN communication between the client device 4 and a second apparatus. Thus, how the pairing process is specifically carried out is not limited to the above example.

The pairing executability information storing section 73 stores pairing executability information indicative of whether the client device 4 is set to carry out pairing. Since the client device 4 includes the input section 56, a user can make an entry on the input section 56 to store pairing executability information in the pairing executability information storing section 73.

The setting information storing section 74 stores various information received from a pairing target. The setting information storing section 74 stores, for example, (i) wireless telecommunication setting information indicative of content of settings for use in a wireless telecommunication with a pairing target and (ii) information for identification of a pairing target apparatus.

[Detailed Configuration of Router 1]

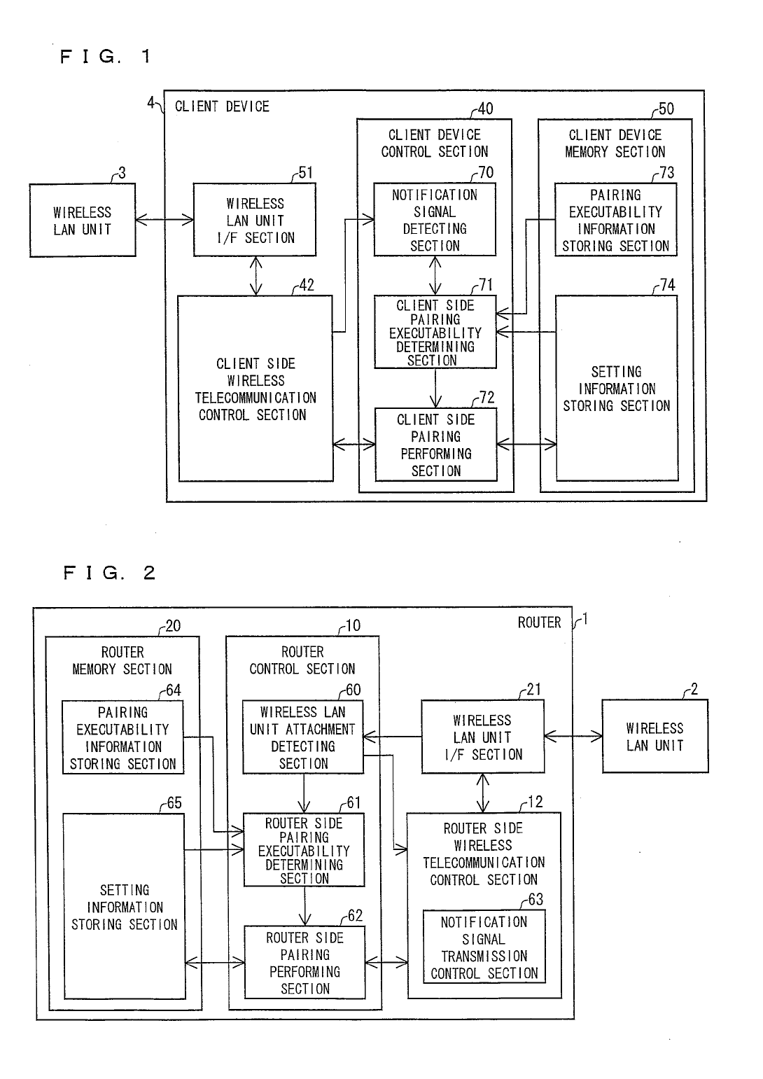

The following describes the configuration of the router 1 in further detail with reference to FIG. 2. FIG. 2 is a block diagram illustrating a main configuration of the router 1. As illustrated in FIG. 2, the router control section 10 includes: a wireless LAN unit attachment detecting section (attachment detecting means) 60; a router side pairing execution determining section (relay apparatus side executability determining means) 61; and a router side pairing performing section (upon-attachment pairing means) 62. The router side wireless telecommunication control section 12 includes a notification signal transmission control section (notification control means; request transmitting means) 63. The router memory section 20 includes: a pairing executability information storing section (relay apparatus side executability information storing section) 64; and a setting information storing section 65.

The wireless LAN unit attachment detecting section 60 detects connection of the wireless LAN unit 2 with the wireless LAN unit I/F section 21. The wireless LAN unit attachment detecting section 60, upon detection of connection of the wireless LAN unit 2, communicates the detection of connection to the router side pairing execution determining section 61.

The router side pairing execution determining section 61 refers to the pairing executability information storing section 64 to check whether the router 1 is currently set to carry out pairing, and thus determines whether the router 1 can carry out pairing. The router side pairing execution determining section 61, in a case where it has determined carrying out of pairing, instructs the router side pairing performing section 62 to carry out pairing.

The present embodiment assumes that it is upon receipt from the wireless LAN unit attachment detecting section 60 of a communication indicative of detection of connection of the wireless LAN unit 2 that the router side pairing execution determining section 61 determines whether the router 1 can carry out pairing. When the router side pairing execution determining section 61 determines whether the router 1 can carry out pairing may, however, be any timing (i) after the router 1 is turned on and (ii) before the router side pairing execution determining section 61 instructs the router side pairing performing section 62 to carry out pairing.

The router side pairing performing section 62, upon receipt of an instruction by the router side pairing execution determining section 61 to carry out pairing, (i) checks whether a preset temporal condition is met, and (ii) in a case where it has determined that the temporal condition is met, carries out a pairing process. Carrying out a pairing process allows a wireless LAN communication between the router 1 and a second apparatus (in the present embodiment, the client device 4).

The temporal condition is set so that the router 1 carries out pairing during a predetermined limited period. The period for pairing is thus limited to a predetermined period for the following reason: The router 1, when carrying out a pairing process for an apparatus, cannot communicate with another apparatus with which it has already been paired. The router 1 may thus cause a problem if arranged to carry out pairing constantly.

In the router 1, the router side pairing performing section 62, in a case where it has received within a predetermined period an instruction to carry out pairing, carries out a pairing process. The predetermined period is hereinafter referred to as “pairing executable period.” How the pairing executable period is set is not particularly limited. The pairing executable period may be, for example, a predetermined period after the router 1 is turned on. In this case, the router side pairing performing section 62 can determine, with use of a timer that starts counting the above predetermined period when the router 1 is turned on, whether it has received an instruction within the pairing executable period. The pairing executable period may alternatively be, for example, a predetermined period after the wireless LAN unit attachment detecting section 60 has detected connection of the wireless LAN unit 2 with the wireless LAN unit I/F section 21.

The notification signal transmission control section 63, upon connection of the wireless LAN unit 2 with the wireless LAN unit I/F section 21, causes the wireless LAN unit 2 to start a broadcast transmission of a notification signal to an area surrounding the router 1. The notification signal transmission control section 63, after the start of a broadcast transmission of a notification signal, causes the wireless LAN unit 2 to carry out a broadcast transmission of a notification signal at predetermined intervals. The notification signal is a signal for informing an apparatus of the presence of (i) a connectable wireless network or (ii) another apparatus that is connectable.

The notification signal is broadcast to be received by an apparatus (in the present embodiment, the client device 4) that is capable of a wireless LAN communication and that is present in the area surrounding the router 1. The client device 4 can thus recognize the presence of a wireless LAN network, and carry out pairing with respect to the router 1 to connect to the wireless LAN network.

The notification signal transmission control section 63 incorporates in the notification signal a pairing request signal for requesting pairing with the router 1, and thus transmits the notification signal. The notification signal, in which the pairing request signal is incorporated, is received by the client device 4, which then starts a process of pairing with the router 1 in response.

The pairing executability information storing section 64 stores pairing executability information indicative of whether the router 1 is currently set to carry out pairing. The present embodiment assumes that the pairing executability information storing section 64 stores, as the pairing executability information, information indicating that the router 1 does not carry out pairing.

In the above case, the router side pairing execution determining section 61 determines, (i) in a case where the pairing executability information storing section 64 stores pairing executability information, that the router 1 does not carry out pairing, and (ii) in a case where the pairing executability information storing section 64 stores no pairing executability information, that the router 1 carries out pairing. Naturally, the pairing executability information storing section 64 may alternatively store, as the pairing executability information, information indicating that the router 1 carries out pairing.

Since the router 1 includes no input section, it receives pairing executability information via, for example, the LAN side communication I/F section 22 or the WAN side communication I/F section 23 so that the pairing executability information storing section 64 stores the pairing executability information.

The setting information storing section 65 stores various information received from a pairing target. The setting information storing section 65 stores, for example, (i) wireless telecommunication setting information indicative of content of settings for use in a wireless telecommunication with a pairing target and (ii) information for identification of a pairing target apparatus.

[Flow of Process Carried Out by Router 1]

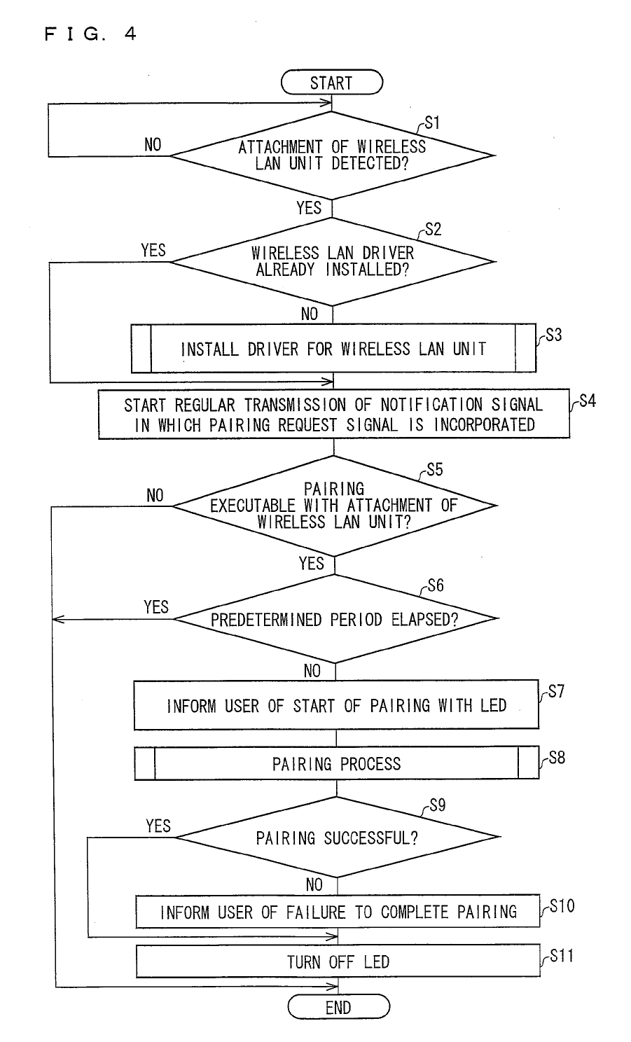

The following describes, with reference to FIG. 4, a flow of a process carried out by the router 1 in the communication system 5. FIG. 4 is a flowchart illustrating an example process carried out by the router 1.

As illustrated in FIG. 4, the wireless LAN unit attachment detecting section 60 of the router 1 waits for the wireless LAN unit 2 to connect to the wireless LAN unit I/F section 21 (S1). When the wireless LAN unit attachment detecting section 60 has detected attachment of a wireless LAN unit, that is, connection of the wireless LAN unit 2 with the wireless LAN unit I/F section 21 (YES in S1), the wireless LAN unit attachment detecting section 60 checks whether the router 1 has already installed a wireless LAN driver in itself (S2).

If the wireless LAN unit attachment detecting section 60 has determined that the router 1 has not yet installed a wireless LAN driver in itself (NO in S2), the wireless LAN unit attachment detecting section 60 installs in the router 1 a wireless LAN driver for the wireless LAN unit 2 (S3). The wireless LAN driver may be stored in the router memory section 20 in advance, or may be obtained via the LAN side communication I/F section 22 or the WAN side communication I/F section 23.

The wireless LAN driver is software to carry out a wireless LAN communication via the wireless LAN unit 2. The router 1, if it has not installed a wireless LAN driver in itself, cannot carry out a wireless LAN communication via the wireless LAN unit 2. That is why the wireless LAN unit attachment detecting section 60 checks in S2 whether the router 1 has already installed a wireless LAN driver in itself. In the example of FIG. 2, the router side wireless telecommunication control section 12 corresponds to a wireless LAN driver. Thus, in the case where the router 1 has a configuration illustrated in FIG. 2, the wireless LAN unit attachment detecting section 60 determines in S2 that the router 1 has already installed a wireless LAN driver.

In the case where the router 1 has already installed a wireless LAN driver (YES in S2) or after the router 1 has installed a wireless LAN driver in S3, the notification signal transmission control section 63 starts a regular transmission of a notification signal in which a pairing request signal is incorporated (S4).

Then, the wireless LAN unit attachment detecting section 60 communicates, to the router side pairing execution determining section 61, detection of attachment of the wireless LAN unit 2. The router side pairing execution determining section 61, upon receipt of such a communication, checks whether the router 1 is set to carry out pairing (S5). Specifically, the router side pairing execution determining section 61 determines, on the basis of pairing executability information stored in the pairing executability information storing section 64, whether the router 1 is set to carry out pairing when the wireless LAN unit attachment detecting section 60 has detected attachment of the wireless LAN unit 2.

In a case where the router side pairing execution determining section 61 has determined, when the wireless LAN unit attachment detecting section 60 has detected attachment of the wireless LAN unit 2, that the router 1 is not set to carry out pairing (NO in S5), the router side pairing execution determining section 61, since it does not need to carry out pairing, gives no instruction to carry out pairing, and ends the process.

In a case where the router side pairing execution determining section 61 has determined that the router 1 is set to carry out pairing (YES in S5), the router side pairing execution determining section 61 instructs the router side pairing performing section 62 to carry out pairing.

The router side pairing performing section 62, upon receipt of the instruction to carry out pairing, checks whether the instruction has been given after a predetermined pairing executable period has elapsed (S6). In a case where the router side pairing performing section 62 has determined that the instruction has been given after the predetermined pairing executable period has elapsed (YES in S6), the router side pairing performing section 62 carries out no pairing process because it does not need to carry out pairing.

In a case where the router side pairing performing section 62 has determined that the instruction has been given within the predetermined pairing executable period (NO in S6), the router side pairing performing section 62 instructs the lighting control section 16 to turn on the LED 25 so as to inform a user of a start of pairing (S7). How to inform a user of the start of pairing is not limited to the above example. The router side pairing performing section 62 may alternatively, for example, instruct the sound control section 15 to cause the sound output section 24 to produce a predetermined information sound. Further alternatively, the router side pairing performing section 62 may use a sound and lighting of the LED 25 in combination to inform a user of the start of pairing.

Next, the router side pairing performing section 62 carries out a pairing process (S8). For the pairing process, the router side pairing performing section 62 switches to a pairing mode. The router side pairing performing section 62 thus switches to the pairing mode to be ready for pairing. The router side pairing performing section 62 carries out pairing with respect to an apparatus (in the present example, the client device 4) that has received the notification signal of which the notification signal transmission control section 63 started a transmission in S4 and in which a pairing request signal is incorporated.

The router side pairing performing section 62 then checks whether it has carried out pairing successfully (S9). How to determine whether the router side pairing performing section 62 has carried out pairing successfully is not particularly limited. The router side pairing performing section 62 may determine, (i) in a case where, for example, the setting information storing section 65 stores information such as wireless telecommunication setting information and information for identification of a pairing target apparatus, that the router side pairing performing section 62 has carried out pairing successfully, and (ii) in a case where the router side pairing performing section 62 cannot recognize within a predetermined period after it has switched to the pairing mode that the setting information storing section 65 stores the above information, that the router side pairing performing section 62 has carried out pairing unsuccessfully.

In the case where the router side pairing performing section 62 has determined that it has carried out pairing unsuccessfully (NO in S9), the router side pairing performing section 62 informs the user of the failure to complete pairing (S10). The router side pairing performing section 62 can inform the user of such a failure by, for example, (i) instructing the sound control section 15 to cause the sound output section 24 to produce a sound for informing the user of the failure to complete pairing, or (ii) instructing the lighting control section 16 to turn on the LED 25 in a first color as in S7 or in a second color different from the first color in S7.

The router side pairing performing section 62, after informing the user of the failure to complete pairing, instructs the lighting control section 16 to turn off the LED 25, which the router side pairing performing section 62 has instructed the lighting control section 16 to turn on in S7 (S11), and ends the process. Since the router side pairing performing section 62 has carried out pairing unsuccessfully in this case, the router 1 and the client device 4 continue to be incapable of a wireless LAN communication with each other.

In a case where the router side pairing performing section 62 has determined that it has carried out pairing successfully (YES in S9), the router side pairing performing section 62 instructs the lighting control section 16 to turn off the LED 25, which the router side pairing performing section 62 has instructed the lighting control section 16 to turn on in S7 (S11), and ends the process. Since the router side pairing performing section 62 has carried out pairing successfully in this case, the router 1 and the client device 4 become capable of a wireless LAN communication with each other.

The flowchart of FIG. 4 merely illustrates an example of the process carried out by the router 1. The process carried out by the router 1 is thus not limited to the example. The wireless LAN unit attachment detecting section 60 may alternatively, for example, communicate detection of attachment of the wireless LAN unit 2 when the wireless LAN unit attachment detecting section 60 has detected attachment of the wireless LAN unit 2 in S1. In this case, the steps S2 through S4 may be carried out in parallel with the steps S5 and S6.

The flowchart of FIG. 4 includes the step S2, in which the wireless LAN unit attachment detecting section 60 checks whether the router 1 has already installed a wireless LAN driver in itself. The step S2 and its subsequent step S3 may, however, be omitted in a case where a wireless LAN unit 2 connectable with the router 1 is determined in advance, and the router 1 has already installed in itself a wireless LAN driver for such a wireless LAN unit 2.

In the above example, the notification signal transmission control section 63 included in the router side wireless telecommunication control section 12 transmits a notification signal in which a pairing request signal is incorporated. The pairing request signal may, however, alternatively be transmitted separately from the notification signal.

In the above alternative case, the transmission of the pairing request signal may be controlled by the notification signal transmission control section 63 or by a section outside the router side wireless telecommunication control section 12 (for example, the wireless LAN unit attachment detecting section 60 or the router side pairing execution determining section 61).

In the case where the transmission of the pairing request signal is controlled by a member outside the router side wireless telecommunication control section 12, the router side wireless telecommunication control section 12 operates identically to a wireless LAN driver that has been in common use. Thus, the router side wireless telecommunication control section 12 can, in this case, simply be such a wireless LAN driver that has been in common use.

Further, after the process has ended without carrying out pairing because (i) pairing is not executable (that is, the pairing executability information storing section 64 stores pairing executability information indicating that the router 1 is set to not carry out pairing) or (ii) a pairing instruction has been given after the pairing executable period has elapsed, there is no need to transmit a notification signal in which a pairing request signal is incorporated. Thus, in the case where the process has ended without carrying out pairing, the notification signal transmission control section 63 may be instructed to switch from (i) the state in which it carries out a regular transmission of a notification signal in which a pairing request signal is incorporated to (ii) a state in which it carries out a regular transmission of a notification signal in which no pairing request signal is incorporated.

The notification signal transmission control section 63 may alternatively be arranged to (i) transmit a notification signal in which a pairing request signal is incorporated, only for a predetermined period (for example, one minute) after the start of transmission of a notification signal, and (ii) transmit, after the predetermined period, a notification signal in which no pairing request signal is incorporated.

[Flow of Process Carried Out by Client Device 4]

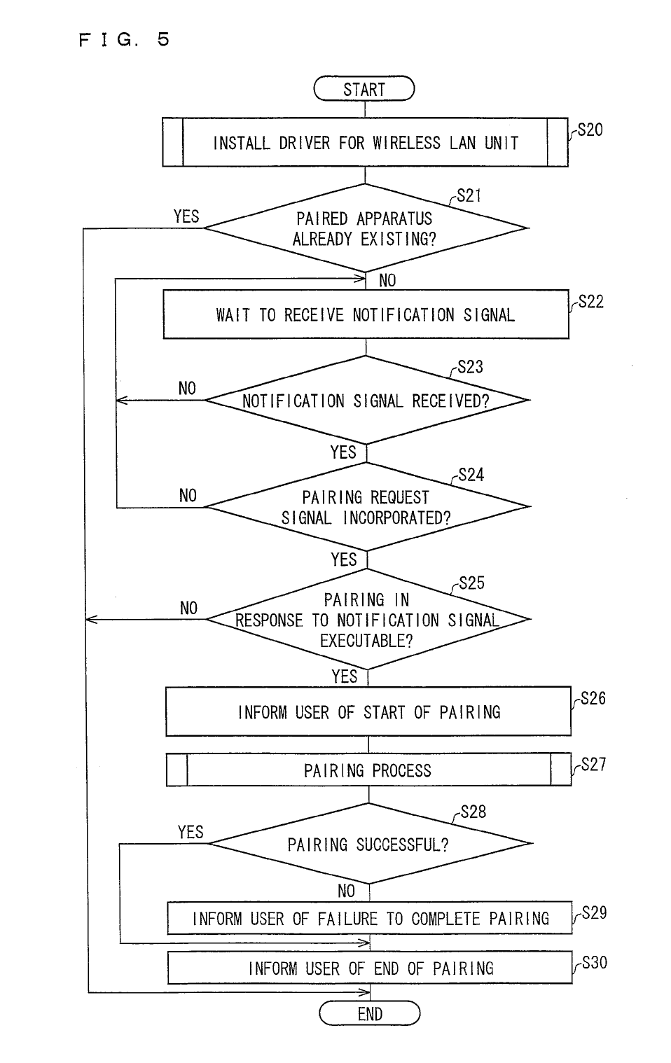

The following describes, with reference to FIG. 5, a flow of a process carried out by the client device 4. FIG. 5 is a flowchart illustrating an example process carried out by the client device 4.

First, the client device 4 installs in itself a driver for the wireless LAN unit 3 (S20). The client device 4 thus installs in itself a driver for the wireless LAN unit 3 at any timing before the step S21 and its subsequent steps are carried out. The step S20 is omitted in a case where the client device 4 has installed in itself a driver for the wireless LAN unit 3 in advance.

In a state where a driver for the wireless LAN unit 3 is installed in the client device 4, the client side pairing execution determining section 71 checks whether there exists an apparatus with which the client device 4 has already been paired (S21). The client side pairing execution determining section 71 may check, on the basis of, for example, whether the setting information storing section 74 stores wireless telecommunication setting information, whether there exists an apparatus with which the client device 4 has already been paired.

In a case where the client side pairing execution determining section 71 has determined that there exists an apparatus with which the client device 4 has already been paired (YES in S21), the client side pairing execution determining section 71, since it does not need to carry out pairing, gives no instruction to carry out pairing, and ends the process.

In a case where the client side pairing execution determining section 71 has determined that there exists no apparatus with which the client device 4 has already been paired (NO in S21), the client side pairing execution determining section 71 instructs the notification signal detecting section 70 to wait to receive a notification signal. The notification signal detecting section 70, in response to the instruction by the client side pairing execution determining section 71, waits to receive a notification signal (S22 and S23).

In a case where the notification signal detecting section 70 has determined receipt of a notification signal (YES in S23), the notification signal detecting section 70 checks whether the notification signal, of which it has determined receipt, includes a pairing request signal incorporated in itself (S24).

In a case where the notification signal detecting section 70 has determined that the notification signal includes no pairing request signal incorporated in itself (NO in S24), the notification signal detecting section 70 returns to the step S22 to wait to receive a notification signal. In a case where the notification signal detecting section 70 has determined that the notification signal includes a pairing request signal incorporated in itself (YES in S24), the notification signal detecting section 70 communicates detection of the incorporation to the client side pairing execution determining section 71.

Next, the client side pairing execution determining section 71, upon receipt of the communication indicating that the notification signal detecting section 70 has determined receipt of the notification signal in which a pairing request signal is incorporated, checks whether pairing in response to the notification signal is executable, that is, checks at the time of receipt of the notification signal whether the client device 4 is set to carry out pairing (S25). Specifically, the client side pairing execution determining section 71 checks, on the basis of pairing executability information stored in the pairing executability information storing section 73, whether the client device 4 is set to carry out pairing.

In a case where the client side pairing execution determining section 71 has determined that the client device 4 is not set to carry out pairing (NO in S25), the client side pairing execution determining section 71, since it does not need to carry out pairing, gives no instruction to carry out pairing, and ends the process.

In a case where the client side pairing execution determining section 71 has determined that the client device 4 is set to carry out pairing (YES in S25), the client side pairing execution determining section 71 instructs the client side pairing performing section 72 to carry out pairing.

The client side pairing performing section 72, upon receipt of the instruction to carry out pairing, informs a user of a start of pairing (S26). How to inform a user of the start of pairing is not particularly limited. The client side pairing performing section 72 may, for example, instruct the display control section 46 to cause the display section 55 to display a message indicative of the start of pairing.

The client side pairing performing section 72 then carries out a pairing process (S27). For the pairing process, the client side pairing performing section 72 first switches to a pairing mode. The client side pairing performing section 72 thus switches to the pairing mode to be ready for pairing. The client side pairing performing section 72 carries out pairing with respect to an apparatus (in the present example, the router 1) that has transmitted the notification signal, of which the notification signal detecting section 70 has determined receipt in S23.

Next, the client side pairing performing section 72 checks whether it has carried out pairing successfully (S28). How to check whether the client side pairing performing section 72 has carried out pairing successfully is not particularly limited. The client side pairing performing section 72 may determine, (i) in a case where, for example, the setting information storing section 74 stores information such as wireless telecommunication setting information and information for identification of a pairing target apparatus, that the client side pairing performing section 72 has carried out pairing successfully, and (ii) in a case where the client side pairing performing section 72 cannot recognize within a predetermined period after it has switched to the pairing mode that the setting information storing section 74 stores the above information, that the client side pairing performing section 72 has carried out pairing unsuccessfully.

In the case where the client side pairing performing section 72 has determined that it has carried out pairing unsuccessfully (NO in S28), the client side pairing performing section 72 informs the user of the failure to complete pairing (S29). The client side pairing performing section 72 can inform the user of such a failure by, for example, (i) instructing the display control section 46 to cause the display section 55 to display a message indicative of the failure to complete pairing, or (ii) instructing the sound control section 45 to cause the sound output section 54 to produce a sound for informing the user of the failure to complete pairing.

The client side pairing performing section 72, after informing the user of the failure to complete pairing, informs the user of an end of the pairing process (S30), and ends the process. Since the client side pairing performing section 72 has carried out pairing unsuccessfully in this case, the router 1 and the client device 4 continue to be incapable of a wireless LAN communication with each other. The client side pairing performing section 72 can inform the user of such an end of pairing by, for example, (i) instructing the display control section 46 to cause the display section 55 to display a message indicative of the end of pairing, or (ii) instructing the sound control section 45 to cause the sound output section 54 to produce a sound for informing the user of the end of pairing.

In a case where the client side pairing performing section 72 has determined that it has carried out pairing successfully (YES in S28), the client side pairing performing section 72 informs the user of an end of pairing as above (S30), and ends the process. Since the client side pairing performing section 72 has carried out pairing successfully in this case, the router 1 and the client device 4 become capable of a wireless LAN communication with each other.

The flowchart of FIG. 5 merely illustrates an example of the process carried out by the client device 4. The process carried out by the client device 4 is thus not limited to the example. The step S21, in which the client side pairing execution determining section 71 checks whether there exists an apparatus with which the client device 4 has already been paired, may be carried out, for example, after (i) the notification signal detecting section 70 has determined in S23 receipt of a notification signal or after (ii) the notification signal detecting section 70 has determined in S24 receipt of a notification signal including a pairing request signal incorporated in itself.

[Variation]

The above embodiment is an example in which the wireless LAN unit attachment detecting section 60 first detects attachment of the wireless LAN unit 2, and the router side pairing execution determining section 61 then determines whether the router 1 can carry out pairing.

The router 1 may alternatively carry out pairing without determining whether it can carry out pairing. Similarly, the client device 4 may carry out pairing without determining whether it can carry out pairing. In other words, both the router side pairing execution determining section 61 and the client side pairing execution determining section 71 can be omitted.

Including the router side pairing execution determining section 61, however, allows pairing to be carried out only during a user's desired period. Including the client side pairing execution determining section 71 allows pairing to be carried out only during a user's desired period, and also prevents pairing from being carried out in a case where pairing should not be carried out, for example, in a case where the client device 4 has already been paired with an apparatus. Thus, the router side pairing execution determining section 61 and the client side pairing execution determining section 71 are preferably included.

The above embodiment is an example involving a transmission of a notification signal in which a pairing request signal is incorporated. The pairing request signal is, however, not necessarily incorporated in the notification signal. With the arrangement in which no pairing request signal is incorporated in the notification signal, the step S4 in the flowchart of FIG. 4 involves a transmission of only a notification signal, and the step S24 in the flowchart of FIG. 5 is omitted. Thus, with the above arrangement, it is simply upon detection of receipt of a notification signal that the notification signal detecting section 70 instructs the client side pairing performing section 72 to carry out pairing.

In the case where the client device 4 is arranged to carry out pairing in response to a trigger of determination of receipt of a mere notification signal, however, the client device 4 may switch to the pairing mode even upon receipt of a notification signal transmitted by an apparatus other than the router 1. Any apparatus serving as an access point for wireless telecommunications is arranged to carry out a regular broadcast transmission of a notification signal in operation.

Thus, a preferable arrangement is that the router 1 transmits a pairing request signal and that the client device 4 carries out pairing upon determination of receipt of the pairing request signal. This arrangement prevents (i) the client device 4 from switching to the pairing mode when no pairing is carried out and (ii) pairing from being carried out with respect to an apparatus that is not intended for pairing.

The above embodiment is an example in which (i) the router 1 switches to the pairing mode upon detection of connection of the wireless LAN unit 2 and (ii) the client device 4 switches to the pairing mode upon detection of receipt of a notification signal. This arrangement may, however, be inverted. Specifically, the above arrangement may be varied such that (i) the client device 4 switches to the pairing mode upon detection of connection of the wireless LAN unit 3 and (ii) the router 1 switches to the pairing mode upon detection of receipt of a notification signal.

The above varied arrangement requires (i) the client device 4 to have a function of detecting attachment of the wireless LAN unit 3 and a function of transmitting a notification signal and (ii) the router 1 to have a function of detecting receipt of a notification signal.

The above embodiment is an example of pairing carried out with respect to the router 1 and the client device 4, which intend to carry out a wireless LAN communication with each other. The present invention is, however, not limited to this example. The present invention is applicable to any apparatus having a function as an access point that transmits a notification signal to inform a user of the presence of a connectable communication network or a connectable apparatus. The present invention is further applicable to any apparatus that carries out pairing with respect to such an apparatus having the above function and that carries out a wireless telecommunication with the apparatus. The wireless telecommunication is not limited to a wireless LAN communication.

The present invention is not limited by the description of the embodiment above, but may be altered in various manners within the scope of the claims. The technical scope of the present invention encompasses any embodiment based on a proper combination of technical means achieved by appropriate modifications within the scope of the claims.

The present invention can alternatively be described as following: A communication apparatus of the present invention is a communication apparatus that carries out pairing with respect to a relay apparatus which transmits a notification signal for informing a presence of a connectable communication network or a connectable apparatus and that carries out a wireless telecommunication with the relay apparatus, with which the communication apparatus has been paired, to communicatively connect to said connectable communication network or said connectable apparatus, the communication apparatus comprising: notification detecting means for detecting receipt of the notification signal; and upon-receipt pairing means for carrying out the pairing with respect to the relay apparatus upon detection, by the notification detecting means, of receipt of the notification signal.

The above arrangement causes the communication apparatus to carry out pairing automatically upon receipt of a notification signal transmitted by a relay apparatus. The arrangement thus allows a user of the communication apparatus to carry out pairing between the communication apparatus and the relay apparatus very easily without having to carry out a particular operation such as switching the communication apparatus to a pairing mode.

The communication apparatus may preferably further include: pairing completion determining means for determining whether the communication apparatus has already been paired, wherein: the upon-receipt pairing means carries out the pairing with respect to the relay apparatus if (i) the notification detecting means has detected the receipt of the notification signal and (ii) the pairing completion determining means has determined that the communication apparatus has not yet been paired.

Communication apparatuses for, e.g., household use normally carry out pairing with respect to an identical relay apparatus. In view of this, the above arrangement prevents pairing from being carried out in a case where the communication apparatus has, at the time of receipt of a notification signal, already carried out pairing. The arrangement thus prevents the communication apparatus, which has already carried out pairing with respect to the relay apparatus, from carrying out pairing again.

The communication apparatus may preferably further include: a communication apparatus side executability information storing section for storing first executability information for use in determination of whether to carry out the pairing; and communication apparatus side executability determining means for determining, with use of the first executability information, whether to carry out the pairing, wherein: the upon-receipt pairing means carries out the pairing with respect to the relay apparatus if (i) the notification detecting means has detected the receipt of the notification signal and (ii) the communication apparatus side executability determining means has determined that the communication apparatus carries out the pairing.

The above arrangement causes the communication apparatus side executability determining means to determine, with use of executability information stored in the communication apparatus side executability information storing section, whether to carry out pairing. Thus, in a case where it is undesirable for the communication apparatus to carry out pairing, it is possible, by storing, in the communication apparatus side executability information storing section, executability information indicating that the communication apparatus is not to carry out pairing, to prevent the communication apparatus from carrying out pairing. In a case where it is desirable for the communication apparatus to carry out pairing, it is possible, by storing, in the communication apparatus side executability information storing section, executability information indicating that the communication apparatus is to carry out pairing, to allow the communication apparatus to carry out pairing.

When the communication apparatus side executability determining means determines whether to carry out pairing is not particularly limited, and may be any timing (i) after the communication apparatus is turned on and (ii) before the communication apparatus carries out pairing.

The communication apparatus may preferably be arranged such that the relay apparatus incorporates in the notification signal a pairing request signal for requesting the pairing with respect to the relay apparatus and transmits the notification signal; and the upon-receipt pairing means carries out the pairing with respect to the relay apparatus upon detection, by the notification detecting means, of the receipt of the notification signal, in which the pairing request signal is incorporated.

As described above, the notification signal is a signal that the relay apparatus transmits to serve its relay function. If there are a plurality of relay apparatuses each having the relay function, the plurality of relay apparatuses each transmit its notification signal. Thus, if the communication apparatus has received a notification signal transmitted by a relay apparatus that is not intended by the user, the communication apparatus may carry out pairing with such a relay apparatus that is not intended by the user.

In view of the above risk, the above arrangement causes the communication apparatus to carry out pairing upon detection of receipt of a notification signal in which a pairing request signal is incorporated. This means that the communication apparatus does not carry out pairing upon detection of receipt of a notification signal in which a pairing request signal is not incorporated. The above arrangement thus reliably allows pairing to be carried out between the communication apparatus and a relay apparatus that is intended by the user.

The advantages achieved by the communication apparatus can also be achieved by a relay apparatus that carries out, with the communication apparatus, the wireless telecommunication to allow the communication apparatus to communicatively connect to the connectable communication network or the connectable apparatus, the relay apparatus transmitting the notification signal and carrying out the pairing with respect to the communication apparatus, which has received the notification signal, to allow the communication apparatus, with which the relay apparatus has been paired, to communicatively connect to the first communication network or the first apparatus via the relay apparatus.

The relay apparatus may preferably be arranged such that the relay apparatus carries out the pairing with respect to the communication apparatus limitedly for a predetermined period after the relay apparatus is turned on.

A relay apparatus, when carrying out a pairing process for an apparatus, normally cannot communicate with another apparatus with which it has already been paired. Thus, a relay apparatus, if arranged to carry out pairing constantly, may be prevented from communicating with such another apparatus with which it has already been paired.

In view of the above risk, the above arrangement causes the relay apparatus to carry out pairing limitedly for a predetermined period after the relay apparatus is turned on. This arrangement prevents the relay apparatus from carrying out pairing when the predetermined period has elapsed after the relay apparatus is turned on. The arrangement thus shortens a period during which the relay apparatus is incapable of communicating with another apparatus with which it has already been paired.

The relay apparatus may preferably further include: a relay apparatus side executability information storing section for storing second executability information for use in determination of whether to carry out the pairing; and relay apparatus side executability determining means for determining, with use of the second executability information, whether to carry out the pairing, wherein: the relay apparatus carries out the pairing with respect to the communication apparatus upon determination, by the relay apparatus side executability determining means, that the relay apparatus carries out the pairing.

The above arrangement causes the relay apparatus side executability determining means to determine, with use of executability information stored in the relay apparatus side executability information storing section, whether to carry out pairing. Thus, in a case where it is undesirable for the relay apparatus to carry out pairing, it is possible, by, for example, storing, in the relay apparatus side executability information storing section, executability information indicating that the relay apparatus is not to carry out pairing, to prevent the relay apparatus from carrying out pairing.

When the relay apparatus side executability determining means determines whether to carry out pairing is not particularly limited, and may be any timing (i) after the relay apparatus is turned on and (ii) before the relay apparatus carries out pairing.

The relay apparatus may preferably further include: a wireless telecommunication section for carrying out the wireless telecommunication with the communication apparatus, the wireless telecommunication section being capable of being attached to and detached from the relay apparatus; an attachment section to which the wireless telecommunication section is attached; notification control means for, while the wireless telecommunication section is attached to the attachment section, causing the wireless telecommunication section to transmit the notification signal; attachment detecting means for detecting the attachment of the wireless telecommunication section in the attachment section; and upon-attachment pairing means for, upon detection, by the attachment detecting means, of the attachment of the wireless telecommunication section, carrying out the pairing with respect to the communication apparatus, which has received the notification signal.

The above arrangement causes the relay apparatus, with the wireless telecommunication section attached thereto, to be set in a state in which it transmits a notification signal and carries out pairing. The communication apparatus, which is to carry out pairing with respect to the relay apparatus, is set, upon receipt of the notification signal, in a state in which it carries out pairing.

In other words, according to the above arrangement, attaching the wireless telecommunication section to the relay apparatus (i) sets both the relay apparatus and the communication apparatus, which are to carry out pairing with respect to each other, each in a state in which it carries out pairing and (ii) allows pairing to be carried out between the relay apparatus and the communication apparatus.

As described above, the above arrangement allows pairing to be carried out automatically in response to a simple attachment of the wireless telecommunication section in the relay apparatus, which attachment is an operation essential for the relay apparatus to serve its function as a relay apparatus. The above attachment consequently allows the communication apparatus to connect to, for example, a communication network via the relay apparatus.

A user of the relay apparatus thus simply attaches the wireless telecommunication section to the relay apparatus, without being aware of an operation for pairing at all, to (i) carry out pairing between the communication apparatus and the relay apparatus and consequently (ii) allow the communication apparatus to connect to, for example, a communication network.

Further, the relay apparatus, which carries out pairing in response to attachment of the wireless telecommunication section, does not require, for example, a button for pairing unlike in the conventional router 100 described in the [Background Art] section above.

The relay apparatus thus can be produced with fewer parts than the conventional router 100, and can consequently reduce a production cost. Further, the relay apparatus, which has no need to include a button, has a larger degree of freedom in exterior design than the conventional router 100, and can consequently have an improved design as well.

The relay apparatus may preferably be arranged such that the upon-attachment pairing means carries out the pairing with respect to the communication apparatus limitedly for a predetermined period after the attachment detecting means has detected the attachment of the wireless telecommunication section.

As described above, a relay apparatus, if arranged to carry out pairing constantly, may be prevented from communicating with another apparatus with which it has already been paired.

In view of the above risk, the above arrangement prevents the relay apparatus from carrying out pairing, even upon detection of attachment of the wireless telecommunication section, after a predetermined period has elapsed. The arrangement thus shortens a period during which the relay apparatus is incapable of communicating with another apparatus with which it has already been paired.

The relay apparatus may preferably further include: request transmitting means for incorporating in the notification signal a pairing request signal for requesting the pairing with respect to the relay apparatus and transmitting the notification signal.

As described above, the notification signal is a signal that the relay apparatus transmits to serve its relay function. Thus, if there is a relay apparatus other than the above relay apparatus, the communication apparatus may receive a notification signal transmitted by the other relay apparatus and carry out pairing with respect to the other relay apparatus.

In view of the above risk, the above arrangement causes the relay apparatus to transmit a notification signal in which a pairing request signal is incorporated. This arrangement reliably allows pairing to be carried out between the relay apparatus and the communication apparatus even if there is a relay apparatus, other than the above relay apparatus, which transmits a notification signal.

A communication system including the communication apparatus and the relay apparatus achieves the advantages achieved by the communication apparatus and the relay apparatus.

The communication apparatus and the relay apparatus may each be in the form of a computer. In such a case, the scope of the present invention encompasses (i) a program for causing a computer to function as each of the means of either the communication apparatus or the relay apparatus so that either the communication apparatus or the relay apparatus is in the form of a computer and (ii) a computer-readable recording medium in which the above program is stored.

The embodiment and concrete examples of implementation discussed in the foregoing explanation for carrying out the invention serve solely to illustrate the technical details of the present invention, which should not be narrowly interpreted within the limits of such an embodiment and concrete examples, but rather may be applied in many variations within the spirit of the present invention, provided that such variations do not exceed the scope of the patent claims set forth below.

### INDUSTRIAL APPLICABILITY

The present invention is applicable to any apparatus that connects, via wireless telecommunications, to a relay apparatus which transmits a notification signal for informing a user of a connectable communication network or a connectable apparatus and that thus communicates with the communication network or the apparatus. The present invention is suitably applicable to, for example, a PC, a smart phone, a mobile telephone, and a game device.

### REFERENCE SIGNS LIST

1 router (relay apparatus)
2 wireless LAN unit (wireless telecommunication section)
4 client device (communication apparatus)
60 wireless LAN unit attachment detecting section (attachment detecting means)
61 router side pairing execution determining section (relay apparatus side executability determining means)
62 router side pairing performing section (upon-attachment pairing means)
63 notification signal transmission control section (notification control means; request transmitting means)
64 pairing executability information storing section (relay apparatus side executability information storing section)
73 pairing executability information storing section (communication apparatus side executability information storing section)
70 notification signal detecting section (notification detecting means)
71 client side pairing execution determining section (communication apparatus side executability determining means; pairing completion determining means)
72 client side pairing performing section (upon-receipt pairing means)

1. A communication apparatus that carries out pairing with respect to a relay apparatus which transmits a notification signal for informing a presence of a connectable communication network or a connectable apparatus and that carries out a wireless telecommunication with the relay apparatus, with which the communication apparatus has been paired, to communicatively connect to said connectable communication network or said connectable apparatus,
the communication apparatus comprising:
a notification detecting section for detecting receipt of the notification signal; and
an upon-receipt pairing section for carrying out the pairing with respect to the relay apparatus upon detection, by the notification detecting section, of receipt of the notification signal.

2. The communication apparatus according to claim 1, further comprising:
a pairing completion determining section for determining whether the communication apparatus has already been paired,
wherein:
the upon-receipt pairing section carries out the pairing with respect to the relay apparatus if (i) the notification detecting section has detected the receipt of the notification signal and (ii) the pairing completion determining section has determined that the communication apparatus has not yet been paired.

3. The communication apparatus according to claim 1, further comprising:
a communication apparatus side executability information storing section for storing first executability information for use in determination of whether to carry out the pairing; and
a communication apparatus side executability determining section for determining, with use of the first executability information, whether to carry out the pairing,
wherein:
the upon-receipt pairing section carries out the pairing with respect to the relay apparatus if (i) the notification detecting section has detected the receipt of the notification signal and (ii) the communication apparatus side executability determining section has determined that the communication apparatus carries out the pairing.

4. The communication apparatus according to claim 1,
wherein:
the relay apparatus incorporates in the notification signal a pairing request signal for requesting the pairing with respect to the relay apparatus and transmits the notification signal; and
the upon-receipt pairing section carries out the pairing with respect to the relay apparatus upon detection, by the notification detecting section, of the receipt of the notification signal, in which the pairing request signal is incorporated.

5. A relay apparatus that carries out, with the communication apparatus according to any one of claims 1 to 4, the wireless telecommunication to allow the communication apparatus to communicatively connect to the connectable communication network or the connectable apparatus,
the relay apparatus transmitting the notification signal and carrying out the pairing with respect to the communication apparatus, which has received the notification signal, to allow the communication apparatus, with which the relay apparatus has been paired, to communicatively connect to the first communication network or the first apparatus via the relay apparatus.

6. The relay apparatus according to claim 5,
wherein:
the relay apparatus carries out the pairing with respect to the communication apparatus limitedly for a predetermined period after the relay apparatus is turned on.

7. The relay apparatus according to claim 5, further comprising:
a relay apparatus side executability information storing section for storing second executability information for use in determination of whether to carry out the pairing; and
a relay apparatus side executability determining section for determining, with use of the second executability information, whether to carry out the pairing,
wherein:
the relay apparatus carries out the pairing with respect to the communication apparatus upon determination, by the relay apparatus side executability determining section, that the relay apparatus carries out the pairing.

8. The relay apparatus according to claim 5, further comprising:
a wireless telecommunication section for carrying out the wireless telecommunication with the communication apparatus, the wireless telecommunication section being capable of being attached to and detached from the relay apparatus;
an attachment section to which the wireless telecommunication section is attached;
a notification control section for, while the wireless telecommunication section is attached to the attachment section, causing the wireless telecommunication section to transmit the notification signal;
an attachment detecting section for detecting the attachment of the wireless telecommunication section in the attachment section; and
an upon-attachment pairing section for, upon detection, by the attachment detecting section, of the attachment of the wireless telecommunication section, carrying out the pairing with respect to the communication apparatus, which has received the notification signal.

9. The relay apparatus according to claim 8,
wherein:
the upon-attachment pairing section carries out the pairing with respect to the communication apparatus limitedly for a predetermined period after the attachment detecting section has detected the attachment of the wireless telecommunication section.

10. The relay apparatus according to claim 5, further comprising:
a request transmitting section for incorporating in the notification signal a pairing request signal for requesting the pairing with respect to the relay apparatus and transmitting the notification signal.

11. A communication system, comprising:
a communication apparatus and the relay apparatus according to claim 5,
the communication apparatus (i) carrying out pairing with respect to a relay apparatus which transmits a notification signal for informing a presence of a connectable communication network or a connectable apparatus and (ii) carrying out a wireless telecommunication with the relay apparatus, with which the communication apparatus has been paired, to communicatively connect to said connectable communication network or said connectable apparatus,
the communication apparatus comprising:
a notification detecting section for detecting receipt of the notification signal; and
an upon-receipt pairing section for carrying out the pairing with respect to the relay apparatus upon detection, by the notification detecting section, of receipt of the notification signal.

12. A method for controlling a communication apparatus that carries out pairing with respect to a relay apparatus which transmits a notification signal for informing a presence of a connectable communication network or a connectable apparatus and that carries out a wireless telecommunication with the relay apparatus, with which the communication apparatus has been paired, to communicatively connect to said connectable communication network or said connectable apparatus,
the method comprising the steps of:
(A) detecting receipt of the notification signal; and
(B) carrying out the pairing with respect to the relay apparatus upon detection, in the step (A), of receipt of the notification signal.

13. A non-transitory computer-readable recording medium for storing a program for operating the communication apparatus according to claim 1, the program causing a computer to function as each of the sections.

14. A non-transitory computer-readable recording medium for storing a program for operating the relay apparatus according to claim 5, the program causing a computer to function as each of the sections.
